(19) United States
(12) Patent Application Publication
(10) Pub. No.: US 2010/0087573 A1
(43) Pub. Date: Apr. 8, 2010

(54) HALOGEN-FREE FLAME RETARDANT THERMOPLASTIC COMPOSITIONS

(75) Inventors: Herve Cartier, Chantilly (FR); Alexis Chopin, Saint Maximin (FR)

Correspondence Address: SABIC - LNP-CE 08CE;SABIC Innovative Plastics - IP LEGAL, ONE PLASTICS AVENUE, PITTSFIELD, MA, 01201-3697, US

(73) Assignee: SABIC Innovative Plastics IP B.V., Pittsfield, MA (US)

(21) Appl. No.: 12/338,498

(22) Filed: Dec. 18, 2008

Related U.S. Application Data
(60) Provisional application No. 61/015,753, filed on Dec. 21, 2007.

(51) Int. Cl. C08K 5/3492; B29C 45/00; B29C 43/00

(52) U.S. Cl. 524/100; 264/328.1; 264/500

(57) ABSTRACT

Flame retardant thermoplastic compositions are provided containing a melamine diamine phosphate; optionally a nitrogen compound based on condensed triazine derivative, and optionally reinforcing fillers; where the composition has excellent chemical resistance to alkaline media. The compositions have utility in battery casing applications as well as other applications wherein a halogen-free flame retardant composition has utility.

### CROSS REFERENCE TO RELATED APPLICATIONS

The present application claims priority to U.S. Provisional Patent Application No. 61/015,753 filed Dec. 21, 2007, which is hereby incorporated by reference in its entirety.

### FIELD OF THE INVENTION

The present invention relates to articles made of a composition containing a halogen free flame retardant thermoplastic composition having excellent chemical resistance towards alkaline electrolytes.

### BACKGROUND OF THE INVENTION

Polypropylene (PP) is one of the most widely used polymers in the industry. For many applications such as electrical, electronics, building, telecoms, appliances etc., it is beneficial for the application to be flame retardant. Over the past decades various PP flame retardant technologies have been developed and are commonly used in the industry. Oldest techniques are based on halogenated organic compounds in combination with a synergist, typically a brominated system, i.e., decabromodiphenylether and antimony trioxide. The main disadvantages of these systems results from the toxicity of the smoke generated during combustion.

The use of hydrated metal compounds such as aluminum trioxide or magnesium hydroxide is a potential halogen free solution but requires very high loading, i.e. greater than 60%, that brings a detrimental effect on key properties such as mechanical and impact strength. Lately, intumescent systems based ammonium polyphosphate (APP), typically ternary blends of APP/Pentaerhytritol/melamine compounds have been developed and commercialized as highly efficient halogen free FR solution for polypropylene. Alkyl diamine phosphates are also known for efficient flame retardant solution for polypropylene but require high loading to work properly (>30%). Another problem with these systems is that they are only capable of meeting the UL94 V0 rating at 1.6 mm or higher thickness.

Battery casings are typically made out of plastic and polypropylene compounds and have a nice fit due to their moderated cost, good mechanical properties, good impact and acceptable strength, easy processability and excellent chemical resistance to fluid such as alkaline or acid electrolytes. Flame retardancy is a key requirement, typically UL94 V0 at 1.6 mm or higher for the battery case and for internal structural components, such as support plates, terminal edge protectors and terminal covers. In view of new regulatory trends the halogen free systems are highly preferred based on the fact that flame retardant (FR) should not negatively interact with the electrochemistry of the battery; which means the FR system should show a high chemical resistance (chemically inert) towards the electrolyte and should not migrate from the casing to the electrolyte, and/or the FR system should not disturb the electrochemistry process.

Polypropylene compounds with brominated flame retardants will meet all the requirements for a battery casing but have the big disadvantage of not meeting halogen free ECO-FR requirements as more requested by industry trends. Also, metal hydrates are clearly not an option in polypropylene due to the loss of mechanical properties as well as their addition seem to have a negative influence on the electrolyte performance.

U.S. Pat. App. No. 2002/0155348 A1 discloses a halogen free flame retardant polypropylene composition based on APP systems for battery casing and is limited to acid batteries. PCT App. No. WO2005/076387 A2 discloses an intumescent flame retardant polymeric composition suitable for battery case where the composition comprises a polyolefins, a nitrogeneous gas generating agent such as melamine cyanurate or ammonium polyphosphate compounds and a water vapor generated agent such as magnesium hydroxide. U.S. Pat. No. 5,137,937 covers the use of C₂-C₈ alkyl diamine phosphate phosphate as efficient intusmescent flame retardant system in polypropylene

APP based systems provide an halogen free option and appear to be a potential solution for acid battery (lead, diluted sulfuric acid) due to their good chemical resistance towards acid. However, they are not a viable option for alkaline batteries due to their solubility in alkaline medium.

Therefore there is a need for a halogen free polypropylene composition that has good mechanical and flame properties and chemical resistance towards alkaline electrolyte that can be used in various applications, such as battery casing applications.

### SUMMARY OF THE INVENTION

The present invention provides flame retardant thermoplastic compositions that include a melamine diamine phosphate; optionally a nitrogen compound based on condensed triazine derivative, and optionally reinforcing fillers; where the composition has excellent chemical resistance to alkaline media. As such, the compositions have utility in battery casing applications as well as other applications wherein a halogen-free flame retardant composition with chemical resistance to alkaline media has utility.

Disclosed herein is a chemically resistant, flame-retardant article including a) a thermoplastics resin, b) 10-50 wt % a C₂-C₈ melamine diamine phosphate, and c) 0-20 wt % of a nitrogen compound selected from condensation products of melamine or reaction products of condensation products of melamine with phosphoric acid, or mixtures thereof; wherein the composition has excellent chemical resistance towards alkaline electrolytes.

Also disclosed herein is a method of making a flame-retardant composition for a battery casing including the steps of; blending a) a thermoplastics resin, b) 10-50 wt % a C₂-C₈ melamine diamine phosphate, and c) 0-20 wt % of a nitrogen compound selected from condensation products of melamine or reaction products of condensation products of melamine with phosphoric acid, or mixtures thereof; and molding the polymer composition.

Disclosed herein as well is a battery casing formed of a flame-retardant composition, including a) a homopolymer of propylene or a copolymer of propylene and ethylene b) 10-50 wt % a C₂-C₈ melamine diamine phosphate, and c) 0-20 wt % of a nitrogen compound selected from condensation products of melamine or reaction products of condensation products of melamine with phosphoric acid, or mixtures thereof; wherein the composition has excellent chemical resistance towards alkaline electrolytes.

Disclosed herein as well is a battery casing formed of a flame-retardant composition, including a) a thermoplastics resin, b) 10-50 wt % a C₂-C₈ melamine diamine phosphate, and c) 0-20 wt % of a nitrogen compound selected from the group consisting of condensation products of melamine or reaction products of condensation products of melamine with phosphoric acid, or mixtures thereof; and d) 0-60 wt % of a reinforcing filler wherein the composition has excellent chemical resistance towards alkaline electrolytes.

In one embodiment, flame retardant article is formed of a composition including a thermoplastic resin, a melamine diamine phosphate, a nitrogen compound and up to 60 wt % of glass fiber.

In another embodiment, the polymer is a copolymer of polypropylene. In another embodiment, the polymer is a blend of polypropylene and poly phenylene oxide. In another embodiment, the polymer is a blend of polypropylene and nylon.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides flame retardant thermoplastic compositions that include a melamine diamine phosphate. In alternative embodiments, the compositions may include a nitrogen compound based on condensed triazine derivative and/or one or more reinforcing fillers. The compositions of the present invention have excellent chemical resistance to alkaline media. As such, the compositions have utility in applications wherein chemical resistance to alkaline media is beneficial, such as in battery casing applications.

As such, in a first aspect, the compositions of the present invention include a thermoplastic resin. Thermoplastic resins that may be in the present invention include, but are not limited to, polyolefins, nylons such as nylon 6, nylon 66, nylon 11, nylon 12, polyesters such as poly(butylene terephthalate), poly(ethylene terephthalate), styrenic resins such as acrylonitrile butadiene styrene (ABS), poly phenylene oxides, or a combination including at least one of the forgoing polymers. Examples of polyolefins that may be used in the present invention include, but are not limited to, polypropylene, thermoplastic elastomers and polyethylene or subset plastic materials within each one of these members. For example, homopolymer or copolymer of polypropylene, high impact co-polymer polypropylene, random co-polymer polypropylene, atactic polypropylene, crosslinked polypropylene (XLPP), low density polyethylene (VLDPE), low density polyethylene (LDPE), medium density polyethylene (MDPE), high density polyethylene (HDPE), linear low density polyethylene (LLDPE), crosslinked polyethylene (XLPE), and ethylene/vinyl acetate copolymer (EVA). Similarly, thermoplastic elastomers may be based on polypropylene or polyethylene backbones and may further contain dispersed rubber particles that may be either thermoplastic or thermoset (e.g. dynamically vulcanized). Examples include but are not limited to ethylene propylene diene monomer (EPDM), maleated propylene diene monomer (m-EPDM), ethylene-polypropylene copolymer, maleated ethylene-polypropylene copolymer (m-EP copolymers). Also included are styrene polymers such as polystyrene, substituted polystyrene and impact-modified polystyrene containing rubber such as butadiene, acrylonitrile butadiene styrene and other styrene containing copolymers.

In one embodiment of the present invention, the thermoplastic resin used is polypropylene. Examples of polypropylenes useful in the present invention include Equistar® PP 1610 PF and Basell® SE 191 and examples of thermoplastic rubbers useful in the present invention include those in the Kraton® family made by Kraton Polymers. An example of VLDPE is Exact® 3022, made by Exxon Mobil Chemical, which has a density of 0.905 and a melt index of 9 g/10 min. Poly(4-methyl-1-pentene) is a polymer of 4-methylpentene-1 which is similar to polypropylene but has an isobutyl group in place of the methyl group on alternate carbon atoms. An example grade of 4-methylpentene-1 is TPX® from Mitsui Petrochemicals Ltd. Any grade polypropylene mixed with a co-polymer material including, but not limited to, ethylene can be used in the present invention. Examples of polypropylenes useful in the present invention include PP copolymer EP300K from Montell. The polypropylene or polyethylene, in one embodiment, makes up 10 to 85 percent by weight of the composition of the present invention. In another embodiment, the composition includes 50 to 75 percent by weight of polypropylene or polyethylene. In yet another embodiment, the composition includes 50 to 55 percent by weight of polypropylene or polyethylene when used in combination with another polyolefin.

The flame retardant composition used in the present invention is in its most general form is the reaction product of ethylene melamine diamine, ethylene-amines and optionally an amine with phosphoric, gyro phosphoric and/or poly phosphoric acid. There are many amine/phosphorus containing salts which are useful for the present invention. In general these are amine salts of phosphoric acid or lower alkyl esters thereof. In one embodiment of the invention, lower alkyl esters means that C₁-C₈ alkyl ester that has been made of one or more sites on the phosphoric acid group. In one embodiment, lower alkyl esters means C₁-C₄ alkyl esters. In one embodiment of the present invention, the melamine diamine phosphate is an ethylene melamine diamine phosphate

The alkyl melamine diamines which are useful to form alkyl melamine diamine phosphate flame retardants are preferably lower alkyl melamine diamines such as C₂-C₈ alkyl melamine diamines and, in select embodiments, C₂-C₄ alkyl melamine diamines. Examples include 1,2-propylenediamine, 1,3-diaminopropane, iminobispropylamine, N-(2-aminoethyl)-1,3-propylenediamine,N,N'bis-(3-aminopropyl)-ethylenediamine, imethylaminopropylamine, and triethylenediamine.

Ethylene-amines are often made from an industrial method based on ethylene and ammonia, according to Encyclopedia of Chemical Technology, Volume 8, page 82. A typical product distribution is EDA 55%, piperazine (PIP) 1.9%, DETA 23%, amino ethylpiperazine (AEP) 3.5%, TETA 9.9%, TEPA 3.9%, and higher ethylene-amines 2.3%. Other methods for synthesis of ethylene-amines also give similar distributions of the ethylene-amines. All the commercial methods synthesize all ethylene-amines at same time, thus requiring separation. The least expensive method to make one of the flame retardant compositions is to use this mixture of ethylene-amines directly or just the fraction with a boiling point greater than EDA. This will eliminate the costly step of separation and packaging of ethylene-amines into specific chemicals, which are then individually reacted with the acids and amines.

Nitrogen based flame retardants can be used in combination with alkyl melamine diamine phosphates. Suitable nitrogen compounds include those of the formula (I) to (V) or combination including at least one of the forgoing,

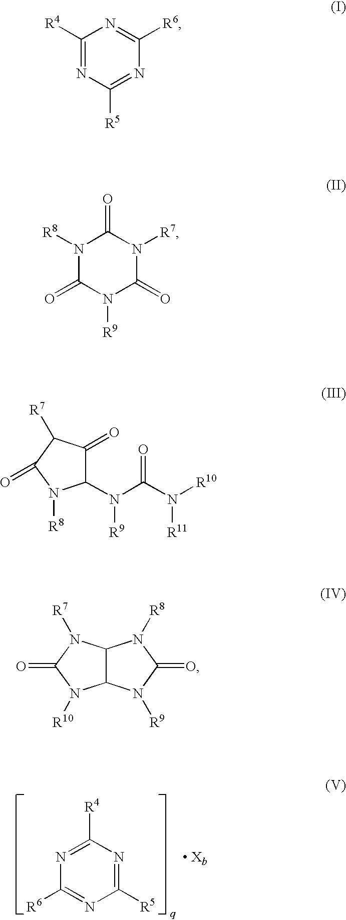

wherein R⁴, R⁵, and R⁶ are independently hydrogen, hydroxy, amino, or mono- or di C₁-C₈ alkyl amino; or C₁-C₈alkyl, C₅-C₁₆cycloalkyl, -alkylcycloalkyl, wherein each may be substituted by a hydroxyl or a C₁-C₄hydroxyalkyl, C₂-C₈alkenyl, C₁-C₈alkoxy, -acyl, -acyloxy, C₆-C₁₂aryl, —OR⁴ and —N(R⁴)R⁵; or are N-alicyclic or N-aromatic, where N-alicyclic denotes cyclic nitrogen containing compounds such as pyrrolidine, piperidine, imidazolidine, piperazine, and the like, and N-aromatic denotes nitrogen containing heteroaromatic ring compounds such as pyrrole, pyridine, imidazole, pyrazine, and the like.

Exemplary flame retardants include melamine pyrophosphate, melamine polyphosphate Melapur 200 from Ciba, melamine cyanurate, Melapur MC25 from Ciba, melamine condensates such as melem, melam, melon and their derivatives, di-melamine Pyrophosphate, Budit 311, ethylene melamine diamine phosphate, Budit 3123 from Budenheim.

The amount of flame retardants present in the composition may be about 2 to about 50 weight percent based on the total weight of the composition, more specifically about 8 to about 30, and yet more specifically about 10 to about 15 weight percent.

The composition may optionally include a filler, including fibrous fillers and/or low aspect ratio fillers. Suitable fibrous filler may include any conventional filler used in polymeric resins and having an aspect ratio greater than 1. Such fillers may exist in the form of whiskers, needles, rods, tubes, strands, elongated platelets, lamellar platelets, ellipsoids, micro fibers, nanofibers and nanotubes, elongated fullerenes, and the like. Where such fillers exist in aggregate form, an aggregate having an aspect ratio greater than 1 will also suffice for the fibrous filler.

Suitable fibrous fillers include, for example, glass fibers, such as E, A, C, ECR, R, S, D, and NE glasses and quartz, and the like may be used as the reinforcing filler. Other suitable inorganic fibrous fillers include those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, iron, nickel, or copper. Other suitable inorganic fibrous fillers include carbon fibers, aramid fibers, stainless steel fibers, metal coated fibers, and the like.

In addition, organic reinforcing fibrous fillers may also be used including organic polymers capable of forming fibers. Illustrative examples of such organic fibrous fillers include poly(ether ketone), polyimide, polybenzoxazole, poly(phenylene sulfide), polycarbonate, aromatic polyamides including aramid, aromatic polyimides or polyetherimides, polytetrafluoroethylene, acrylic resins, and poly(vinyl alcohol). Such reinforcing fillers may be provided in the form of monofilament or multifilament fibers and can be used either alone or in combination with other types of fiber, through, for example, co-weaving or core/sheath, side-by-side, orange-type or matrix and fibril constructions, or by other methods known to one skilled in the art of fiber manufacture.

Non-limiting examples of low aspect fillers include silica powder, such as fused silica, crystalline silica, natural silica sand, and various silane-coated silicas; boron-nitride powder and boron-silicate powders; alkaline earth metal salts; alumina and magnesium oxide (or magnesia); wollastonite, including surface-treated wollastonite; calcium sulfate (as, for example, its anhydride, dihydrate or trihydrate); calcium carbonates including chalk, limestone, marble and synthetic, precipitated calcium carbonates, generally in the form of a ground particulate which often comprises 98% CaCO3 with the remainder being other inorganics such as magnesium carbonate, iron oxide and alumino-silicates; surface-treated calcium carbonates; other metal carbonates, for example magnesium carbonate, beryllium carbonate, strontium carbonate, barium carbonate, and radium carbonate; talc; glass powders; glass-ceramic powders; clay including calcined clay, for example kaolin, including hard, soft, calcined kaolin; mica; feldspar and nepheline syenite; salts or esters of orthosilicic acid and condensation products thereof; silicates including aluminosilicate, calcium silicate, and zirconium silicate; zeolites; quartz; quartzite; perlite; diatomaceous earth; silicon carbide; zinc sulfide; zinc oxide; zinc stannate; zinc hydroxystannate; zinc phosphate; zinc borate; aluminum phosphate; barium titanate; barium ferrite; barium sulfate and heavy spar; particulate aluminum, bronze, zinc, copper and nickel; carbon black, including conductive carbon black; flaked fillers such as glass flakes, flaked silicon carbide, aluminum diboride, aluminum flakes, and steel flakes; and the like. Examples of such fillers well known to the art include those described in “Plastic Additives Handbook, 4th Edition” R. Gachter and H. Muller (eds.), P. P. Klemchuck (assoc. ed.) Hansen Publishers, New York 1993.

The total amount of filler present in the composition may be about 0 to about 60 weight percent, more specifically about 5 to about 35 weight percent, or even more specifically about 10 to about 30 weight percent based on the total weight of the composition. In one embodiment, the ratio of reinforcing filler to non-reinforcing inorganic mineral filler is greater than 1, especially greater than about 1.2, and more especially greater than about 1.5.

The composition may optionally further comprise other additives known in the art. Suitable additives include wear additives, for example, polytetrafluoroethylene (PTFE), molybdenum disulfide (MoS2), graphite, aramide, carbon fibers, carbon powder, combinations comprising at least one of the foregoing wear additives, and the like. The amount of wear additive present in the composition may be about 0 to about 20 weight percent, more specifically about 1 to about 15 weight percent, or even more specifically about 5 to about 10 weight percent based on the total weight of the composition.

The composition may optionally further comprise a charring catalyst, for example, a metal salt of a tungstic acid or a complex oxide acid of tungsten and a metalloid, a tin oxide salt such as sodium tin oxide, and/or ammonium sulfamate. Suitable metal salts include alkali metal salts of a tungstic acid, such as sodium tungstate. By a complex oxide acid of tungsten and a metalloid is meant a complex oxide acid formed by a metalloid such as phosphorous or silicon and tungsten. Exemplary complex oxide acids include silicotungstic acid and phosphotungstic acid. When used, the charring catalyst may be present in an amount of up to about 10 weight percent based on the total weight of the composition, more specifically about 0.1 to about 10 weight percent, and yet more specifically about 0.1 to about 2 weight percent.

Other customary additives may be added to all of the resin compositions at the time of mixing or molding of the resin in amounts as necessary which do not have any deleterious effect on physical properties. For example, coloring agents (pigments or dyes), heat-resistant agents, oxidation inhibitors, organic fibrous fillers, weather-proofing agents, impact modifiers, lubricants, mold release agents, plasticizer, and fluidity enhancing agents, and the like, may be added.

The preparation of the compositions may be achieved by blending the ingredients under conditions for the formation of an intimate blend. All of the ingredients may be added initially to the processing system, or else certain additives may be precompounded with one or more of the primary components.

The blend may be formed by mixing in single or twin-screw type extruders or similar mixing devices that can apply a shear to the components. In one embodiment, separate extruders are used in the processing of the blend. In another embodiment, the composition is prepared by using a single extruder having multiple feed ports along its length to accommodate the addition of the various components. A vacuum may be applied to the melt through at least one or more vent ports in the extruder to remove volatile impurities in the composition.

In one embodiment, the polymer is blended with the flame retardant system and reinforcing filler, such as chopped glass strands, in a Henschel high speed mixer. Other low shear processes including but not limited to hand mixing may also accomplish this blending. The blend is then fed into the throat of a twin-screw extruder via a hopper. Alternately the glass may be incorporated into the composition by feeding unchopped strands directly into the extruder. The dispersed glass fibers are reduced in length as a result of the shearing action on the glass strands in the extruder barrel. Reinforcing fillers used can be short fibers or continuous fibers.

In another embodiment, the reinforcing filler, e.g., glass fiber, is not blended in with the flame retardant polymer system, but it is incorporated into the flame-retardant polymer composition by a process known as pultrusion, which process is described in a number of references, for example, U.S. Pat. Nos. 3,993,726 and 5,213,889. In the pultrusion process, a tow or roving of fibers is pulled through a bath of molten polymer to impregnate the fiber. The impregnated fiber product may be pulled through a means for consolidating the product such as a sizing die. In one embodiment, the impregnated product may be wound on rolls for subsequent use in fabrication processes requiring a continuous product. In yet another embodiment, the fiber impregnated by the composition of the invention may be chopped into pellets or granules, in which the aligned fibers have lengths from 2 mm up to 100 mm. These may be used in conventional molding or extrusion processes for forming articles.

In one embodiment of the invention, the compositions are used to prepare molded articles such as for example, durable articles, structural products, and electrical and electronic components, and the like. The compositions may be converted to articles using common thermoplastic processes such as film and sheet extrusion, injection molding, gas-assisted injection molding, extrusion molding, compression molding and blow molding. Film and sheet extrusion processes may include but not limited to melt casting, blown film extrusion, and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, and the like.

The composition may be used to prepare molded articles including, but not limited to, vessels for chemical industry, tanks, ducts, fittings, pipes, seals, battery holders and parts in the surrounding of alkaline batteries in case of battery leakage.

The tensile modulus and strength were measured by ISO Standard 527/1 using a test piece having a width of 4.0 mm.

Flammability characteristics are based on the procedure of Underwriters Laboratories Inc., Bulletin 94 entitled “Tests for Flammability of Plastic Materials for Parts in Devices and Appliances, UL94” of a 0.8 mm and 1.6 mm test piece in the vertical position. According to this procedure, the materials were classified as V-0, V-1, or V-2 on the basis of the test results.

The compositions described herein have been found to exhibit a Glow Wire Flammability Index (GWFI) as measured according to IEC-60695-2-12 of 960° C. at a test specimen thickness of about 1.6 mm, and dimension of 60.0 by 60.0 mm.

Three FR PP compounds based on Brominated, APP and EDAP flame retardant systems may be evaluated in parallel with respect to physical, mechanical, flame properties and chemical resistance towards alkaline electrolyte e.g., potassium hydroxide (KOH) and automotive cooling liquid such as ethylene glycol.

Chemical resistance may be quantified by measuring the loss of weight of color plaques fully immersed into KOH electrolyte or ethylene glycol at 70° C. as a function of time. Testing for chemical resistance is carried out using the ISO 22088-3 Chemical Resistance/ESCR testing standard with either potassium hydroxide (50% solution) or 1,2 propanediol (80%)+water (20%) as the chemical. In one embodiment, the compositions lose less than 2% by weight when immersed for 2000 hours in a KOH electrolyte or ethylene glycol bath at 70° C. In another embodiment, the compositions lose less than 1% by weight when immersed for 2000 hours in a KOH electrolyte or ethylene glycol bath at 70° C.

The following examples, which are meant to be exemplary, not limiting, illustrate compositions and methods of manufacturing of some of the various embodiments of the halogen free flame retardant polymer compositions and the methods of manufacture described herein.

### Examples

The invention is further illustrated by the following examples. The formulations for the Examples were prepared from the components listed in Table 1 below.

TABLE 1
Flame Retardant PP formulations

| | # 1 | # 2 | # 3 | # 4 |
|---|---|---|---|---|
| PP copolymer EP 300 K | 69.4 | 51.4 | 54.4 | 64.4 |
| Budit 3123 (1) | 30 | | | |
| DECABROMO DE83R (2) | | 20 | | |
| Antimony Trioxide | | 8 | | |
| Budit 3076 (3) | | | 30 | 35 |
| Talcum | | 20 | | |
| Mica | | | 15 | |
| Irganox 1098 | 0.2 | 0.2 | 0.2 | 0.2 |
| Ultranox 626 | 0.2 | 0.2 | 0.2 | 0.2 |
| Stearate de Calcium | 0.2 | 0.2 | 0.2 | 0.2 |
| | 100 | 100 | 100 | 100 |

(1) Ethylene diamine Phosphate based Flame
(2) Decabromodiphenyl ether Flame
(3) Amonium Polyphosphate based Flame

The components were compounded in a co-rotating twin-screw extruder (Werner & Pfleiderer, type ZSK40), using a screw design having a mid range screw severity, at a melt temperature of 150 to 300° C., and at rates of 45 to 100 kilograms per hour. The resulting resin mixtures were then molded into bars using typical injection molding machines, ranging from laboratory-sized machines to commercial sized machines. Mechanical and flammability properties of the composition are shown in Table 2. All the formulations tested showed acceptable mechanical strength for battery casing, and all the formulations exhibited flammability UL94 V0 rating at 1.6 mm.

Table 3 show the chemical resistance of the plaques (molded out of formulations #1 to # 3) towards potassium hydroxide electrolyte at 70° C. It is shown that the formulations based on ammonium polyphosphate showed significant weight loss after 232 hours and are clearly not suitable for being used in alkaline battery casing due to loss of properties of the molded parts induced by the migration of APP into the electrolyte. In addition, this migration is known to be detrimental to the electrochemistry of the electrolyte. The main reason comes from the solubility of APP into alkaline media. Formulation #2 based on brominated FR does show an excellent behavior in terms alkaline chemical resistance but has the big disadvantage of being halogenated.

Formulation #1 (which uses an ethylene melamine diamine phosphate and polypropylene) performs in a satisfactory way and appears to be an excellent halogen free solution for battery casing. Same conclusions can be drawn for the chemical resistance tests made into ethylene glycol.

TABLE 2
Property Profile of Flame Retardant PP formulations

| | ISO | # 1 | # 2 | # 3 | # 4 |
|---|---|---|---|---|---|
| density | 1183 | 1.03 | 1.36 | 1.22 | 1.08 |
| Tensile Strength | 527 | 17 | 30 | 21 | 16 |
| Tensile Elongation at Break | 527 | 70 | 20 | 4.6 | >20 |
| Flexural Strength | 178 | 27 | 30 | 33 | 25 |
| Flexural Modulus | 178 | 1600 | 2400 | 2700 | 1600 |
| Izod Notched Impact | 180 | 3.5 | 11 | 8.1 | na |
| Izod Unnotched Impact | 180 | 25 | 50 | 19 | 25 |
| UL 94 @ 1.6 mm | | V0 | V0 | V0 | V0 |
| UL 94 @ 3.2 mm | | V0 | V0 | V0 | V0 |
| GWFI at 1.6 mm | | pass | pass | pass | pass |

TABLE 3
Weight loss variations for various FR PP systems
in KOH and EG @ 70° C.

| | | |
|---|---|---|
| time (hours) | KOH Potassium Hydroxide | EG Ethylene Glycol |

% loss of weight, formulation # 3, APP FR based

| | | |
|---|---|---|
| 0 | 0 | 0 |
| 432 | −2.9 | −2.7 |
| 1464 | −4.4 | −3.3 |
| 2136 | na | na |

% loss of weight, formulation # 2, Brominated FR

| | | |
|---|---|---|
| 0 | 0 | 0 |
| 432 | −0.1 | 0 |
| 1464 | −0.1 | −0.1 |
| 2136 | −0.1 | −0.1 |

% loss of weight, formulation # 1, EDAP FR based

| | | |
|---|---|---|
| 0 | 0 | 0 |
| 432 | −0.4 | −0.3 |
| 1464 | −0.5 | −0.1 |
| 2136 | −0.4 | 0 |

% loss of weight, formulation # 4, APP FR based

| | | |
|---|---|---|
| 0 | 0 | 0 |
| 432 | −1.9 | −0.4 |
| 1464 | −2.3 | −2.9 |
| 2136 | −4.8 | −4 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A chemically resistant, flame-retardant article comprising:
a) a thermoplastics resin,
b) 10-50 wt % a C₂-C₈ melamine diamine phosphate; and
c) 0-20 wt % of a nitrogen compound selected from condensation products of melamine or reaction products of condensation products of melamine with phosphoric acid, or mixtures thereof; and
wherein the composition has excellent chemical resistance towards alkaline electrolytes.

2. The article of claim 1, wherein the article exhibits a rating of V0 according to UL-94 at 1.6 millimeters thickness.

3. The article of claim 1, wherein the article exhibits a Glow Wire Flammability Index as measured according to IEC-60695-2-12 of 960° C. or greater at about 1.6 millimeter thickness.

4. The article of claim 1, further comprising a reinforcing filler that is selected from glass fibers, talc, mica, organoclays, wollastanite, quartz fibers, carbon fibers, potassium titanate fibers, silicon carbide fibers, boron carbide fibers, gypsum fibers, aluminum oxide fibers, iron fibers, nickel fibers, copper fibers, wollastonite fibers, poly(ether ketone) fibers, polyimide benzoxazole fibers, poly(phenylene sulfide) fibers, polyester fibers, aromatic polyamide fibers, aromatic polyimide fibers, aromatic polyetherimide fibers, acrylic fibers, poly(vinyl alcohol) fibers, polytetrafluoroethylene fibers, or a combination including at least one of the foregoing fillers.

5. The article of claim 1, wherein the thermoplastic resin is selected from polyolefins, nylon 6, nylon 6/6, nylon 11, nylon 12, polyesters, poly(butylene terephthalate), poly(ethylene terephthalate), poly(phenylene oxides), styrenic resins, acrylonitrile butadiene styrene (ABS), or a combination including at least one of the foregoing resins.

6. The article of claim 1, wherein the article comprises a battery casing.

7. The article of claim 6, wherein the thermoplastic resin is selected from a homopolymer of propylene or a copolymer of propylene and ethylene.

8. The article of claim 6, wherein the thermoplastic resin is a polyolefin resin selected from polypropylene homopolymer, polypropylene copolymer, ethylene propylene diene monomer (EPDM), maleated propylene diene monomer (m-EPDM), ethylene-polypropylene copolymer, maleated ethylene-polypropylene copolymer (m-EP copolymers), a thermoplastic elastomer, a thermoplastic rubber, ethylene/vinyl acetate copolymer (EVA), a poly(4-methyl-1-pentene) homopolymer, poly(4-methyl-1-pentene/1-decene) copolymer, very low density polyethylene (VLDPE), (m) low density polyethylene (LDPE), medium density polyethylene (MDPE), high density polyethylene (HDPE), linear low density polyethylene (LLDPE), crosslinked polyethylene (XLPE), crosslinked polypropylene (XLPP), or a combination including at least one of the foregoing resins.

9. A method for forming a flame-retardant composition comprising the steps of:
blending
a) a thermoplastics resin,
b) 10-50 wt % of a C₂-C₈ melamine diamine phosphate flame retardant, and
c) 0-20 wt % of a nitrogen compound selected from condensation products of melamine or reaction products of condensation products of melamine with phosphoric acid, or mixtures thereof; and
molding the polymer composition.

10. The method of claim 9, wherein the molding step is selected from injection molding, compression molding, injection-compression molding, thermoforming, blow molding or a combination including at least one of the molding steps.

11. The method of claim 9, wherein the thermoplastic resin is polypropylene.

12. The method of claim 9, wherein the flame retardant comprises at least one component selected from melamine pyrophosphate, melamine polyphosphate, ethylene melamine diamine phosphate ammonium polyphosphate, or a combination comprising at least one of the forgoing flame retardants.

13. The method of claim 12, wherein the flame retardant comprises ethylene melamine diamine phosphate.

14. The method of claim 9, further comprising a reinforcing filler that is selected from glass fibers, talc, mica, organoclays, wollastanite, quartz fibers, carbon fibers, potassium titanate fibers, silicon carbide fibers, boron carbide fibers, gypsum fibers, aluminum oxide fibers, iron fibers, nickel fibers, copper fibers, wollastonite fibers, poly(ether ketone) fibers, polyimide benzoxazole fibers, poly(phenylene sulfide) fibers, polyester fibers, aromatic polyamide fibers, aromatic polyimide fibers, aromatic polyetherimide fibers, acrylic fibers, poly(vinyl alcohol) fibers, polytetrafluoroethylene fibers, or a combination including at least one of the foregoing fillers.

15. A flame-retardant composition comprising:
a) a thermoplastics resin,
b) 10-50 wt % of a C₂-C₈ melamine diamine phosphate flame retardant, and
c) 0-20 wt % of a nitrogen compound selected from condensation products of melamine or reaction products of condensation products of melamine with phosphoric acid, or mixtures thereof;
wherein the composition has excellent chemical resistance.

16. The composition of claim 15, wherein the thermoplastic resin is polypropylene.

17. The composition of claim 15, wherein the flame retardant comprises at least one component selected from melamine pyrophosphate, melamine polyphosphate, ethylene melamine diamine phosphate ammonium polyphosphate, or a combination comprising at least one of the forgoing flame retardants.

18. The composition of claim 17, wherein the flame retardant comprises ethylene melamine diamine phosphate.

19. The composition of claim 15, further comprising a reinforcing filler that is selected from glass fibers, talc, mica, organoclays, wollastanite, quartz fibers, carbon fibers, potassium titanate fibers, silicon carbide fibers, boron carbide fibers, gypsum fibers, aluminum oxide fibers, iron fibers, nickel fibers, copper fibers, wollastonite fibers, poly(ether ketone) fibers, polyimide benzoxazole fibers, poly(phenylene sulfide) fibers, polyester fibers, aromatic polyamide fibers, aromatic polyimide fibers, aromatic polyetherimide fibers, acrylic fibers, poly(vinyl alcohol) fibers, polytetrafluoroethylene fibers, or a combination including at least one of the foregoing fillers.
